(19) United States
(12) Patent Application Publication
(10) Pub. No.: US 2024/0027078 A1
(43) Pub. Date: Jan. 25, 2024

(54) METHOD FOR OPERATING A HEATING SYSTEM

(71) Applicant: VIESSMANN CLIMATE SOLUTIONS SE, Allendorf (DE)

(72) Inventors: Richard FREITAG, Frankenberg/Haubern (DE); Natalie GUTKNECHT, Battenberg (DE); Julian FACKINER, Muenchhausen (DE)

(73) Assignee: VIESSMANN CLIMATE SOLUTIONS SE, Allendorf (DE)

(21) Appl. No.: 18/039,401

(22) PCT Filed: Nov. 26, 2021
(86) PCT No.: PCT/DE2021/100935

§ 371 Date: May 30, 2023

(30) Foreign Application Priority Data
Dec. 4, 2020 (DE) 10 2020 132 266.6

(51) Int. Cl. F24D 19/10; F24D 3/02; F16L 55/24

(52) U.S. Cl. CPC F24D 19/1009; F24D 3/02; F16L 55/24

(57) ABSTRACT

In a heating system operation method, a heating circuit medium is conveyed through an overall heating circuit flow path and at least through one sub-flow path of the overall path. How much medium is respectively conveyed through the sub-flow paths is controlled, and the medium, in order to clean it of dirt, is routed through an overall path filter. At system start-up, all the medium is routed via the sub-flow path having optionally the at least variable flow resistances or a known and/or unchanging flow resistance, termed reference flow path, and a conveying power reference value is determined and saved. To check the filter fouling state, during system operation, all the medium is again routed through the reference flow path used on start-up, a conveying power value is determined and compared with the reference value and, beginning at a predetermined deviation, a filter fouling signal is generated.

The invention relates to a method for operating a heating system according to the preamble of patent claim 1.

A method for operating a heating system of the above-mentioned type is well-known.

For example, a method for operating a heating system is known from the patent document DE 10 2011 001 223 A1, in which a heating circuit medium is conveyed through an overall flow path of a heating circuit, in which the heating circuit medium is conveyed at least through one of at least two sub-flow paths, belonging to the overall flow path, of the heating circuit, and in which there is control over how much heating circuit medium is respectively conveyed via the sub-flow paths. In the case of this solution, a sub-flow path, which has a large number of variable flow resistances (in particular thermostatic valves), is that sub-flow path comprising the heating elements (illustrated by means of the circle with double line). Another heating circuit, which has only a single variable flow resistance in this case, is that heating circuit with the controllable bypass valve (see reference numeral 4 there).

The further feature according to the preamble of patent claim 1, namely that the heating circuit medium, in order to clean it of dirt, is routed through a filter provided in the overall flow path, of the heating circuit is not disclosed in the above-mentioned document; the applicant assumes, however, that this feature is also already known per se from the prior art.

The invention is based on the object of improving a method for operating a heating system. A method detecting a possible fouling of the filter is to in particular be provided.

This object is solved by means of a method for operating a heating system with the features listed in the characterizing part of patent claim 1.

According to the invention, it is thus provided that when the heating system is started up, all of the heating circuit medium is routed via the sub-flow path, which optionally has the at least variable flow resistances or a known and/or an unchanging flow resistance, also referred to as reference flow path, and a conveying power reference value is determined and saved, and that in order to check a state of fouling of the filter, during operation of the heating system, all of the heating circuit medium is once again routed via the reference flow path, which is used during the start-up, a conveying power value is determined, the latter is compared with the conveying power reference value, and, beginning with a predetermined deviation, a signal indicating a fouling of the filter is generated.

In other words, the method according to the invention is thus characterized in that, in order to check a state of fouling of the filter, the heating circuit medium is routed via the sub-flow path, which can be assessed best with respect to its flow resistance. Such a checking method is significantly more reliable thereby than if one were to perform a corresponding diagnostic on the other sub-flow path because the measured flow rate (or the heating circuit medium quantity, respectively) is influenced strongly by the further heating circuit components, such as, for example, heating elements or radiators, respectively, with the thermostatic valves thereof, or it cannot be ensured, respectively, that the checking does in fact take place in the case of identical settings, for example of the thermostatic valves of the heating elements.

The provision “all of” used twice in the characterizing part of patent claim 1 is to be understood thereby in terms of “essentially all of” (thus at least 90%, preferably 95%, more preferably 100%), namely insofar as smaller leakage flows, which do not influence the reference value formation or the reference value comparison, respectively, via the other sub-flow path are acceptable.

Other advantageous further developments of the method according to the invention follow from the dependent patent claims. For the sake of completeness, reference is also made to the documents EP 0 808 205 B1, EP 1 897 439 A1, and U.S. Pat. No. 9,366,448 B2. Even though devices for the detection of a filter foiling are already known from all three publications, it is not provided in the case of any of these solutions to convey the flow during the measured value acqui-sition via the sub-flow path, which can be assessed best with respect to its flow resistance.

Reference is additionally also made to the documents DE 10 2016 218 227 A1 and DE 20 2010 004 292 U1.

The method according to the invention including its advantageous further developments according to the dependent patent claims will be explained in more detail below on the basis of the graphic illustration of a preferred exemplary embodiment, in which

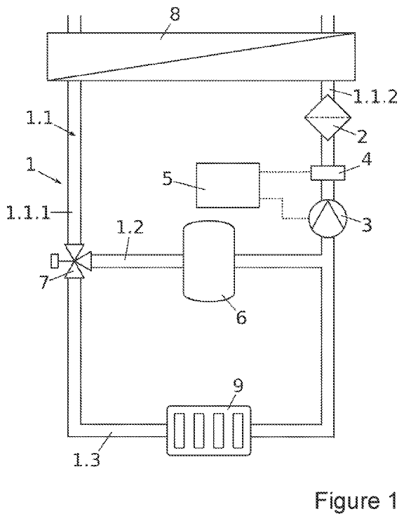

FIG. 1 schematically shows the heating circuit of a heating system comprising two sub-flow paths.

The sole figure illustrates a heating circuit for carrying out the method according to the invention, in which a heating circuit medium is conveyed through an overall flow path 1.1 of a heating circuit 1, in which the heating circuit medium is conveyed at least through one of at least two sub-flow paths 1.2, 1.3, belonging to the overall flow path 1.1, of the heating circuit 1, in which there is control over how much heating circuit medium is respectively conveyed via the sub-flow paths 1.2, 1.3, and in which the heating circuit medium, in order to clean it of dirt, is routed through a filter 2 provided in the overall flow path 1.1 of the heating circuit 1.

It is now essential for the method according to the invention that when the heating system is started up (which can be, but does not have to be during the first start-up, for example), essentially all of the heating circuit medium (see above) is routed via the sub-flow path 1.2, also referred to as reference flow path 1.2, which optionally has the at least variable flow resistances or a known and/or an unchanging flow resistance, and a conveying power reference value is determined and saved, and that in order to check a state of fouling of the filter 2, during operation of the heating system essentially all of the heating circuit medium (see above) is once again routed via the reference flow path used during the start-up, a conveying power value is determined, the latter is compared with the conveying power reference value, and, beginning with a predetermined deviation, a signal indicating a fouling of the filter 2 is generated.

It is preferred thereby that the heating circuit medium is supplied to the heating circuit 1 via a flow line 1.1.1 belonging to the overall flow path 1.1 and is discharged from the heating circuit 1 via a return line 1.1.2 belonging to the overall flow path 1.1. It is likewise preferably provided that the heating circuit medium is routed via a heat exchanger 8, which connects the return line 1.1.2 to the flow line 1.1.1. It is additionally preferred that the heat exchanger 8 is formed as condenser of a heat pump and to emit heat to the heating circuit 1. The heating circuit medium is furthermore preferably routed through the filter 2, which is arranged on the return line 1.1.2 of the heating circuit 1.

It is furthermore preferred that, coming from the overall flow path 1.1, preferably from the flow line 1.1.1, the heating circuit medium is optionally routed to the reference flow path 1.2 and/or to the other sub-flow path 1.3 by means of a main valve 7. It is preferred thereby that a 4/3 way valve is used as main valve 7. It is further preferred that the heating circuit medium flowing through the other sub-flow path 1.3, which does not form the reference flow path 1.2, is routed through at least one radiator 9 (for example a heating element).

It is likewise preferred that when the heating system is started up and/or when the state of fouling of the filter 2 is checked, the heating circuit medium is routed through the reference flow path 1.2, which, apart from the main valve 7, is preferably formed in a valve-free manner. When the heating system is started up and/or when the state of foiling of the filter 2 is checked, the heating circuit medium is thereby preferably routed through the reference flow path 1.2, which, apart from heat losses that cannot be prevented, such as, for example, the natural heat emission of pipelines, is formed in a heat exchanger-free manner. It is additionally preferred that when the heating system is started up and/or when the state of fouling of the filter 2 is checked, the heating circuit medium is routed through a buffer storage 6, which is arranged in the reference flow path 1.2. Said buffer storage serves in particular the purpose of providing warm heating circuit medium, if the evaporator of the heat pump has to be de-iced, which can happen during the cold season.

It is furthermore preferably provided that the heating circuit medium is conveyed through the heating circuit 1 by means of a heating circuit pump 3 and that a heating circuit medium quantity, which is conveyed through the heating circuit 1, is determined by means of a quantity measuring means 4. It is additionally preferred that the conveying power reference value and/or the conveying power value (if applicable by including further operating variables) is optionally determined on the basis of the speed of the heating circuit pump 3 and on the basis of the heating circuit medium quantity acquired by means of the quantity measuring means 4. Lastly, it is preferably also provided that the conveying power reference value determined when the heating system is started up is stored in an electronic control means 5 of the heating system.

The method according to the invention for operating a heating system works as follows according to a preferred exemplary embodiment:

When the heating system is started up first, the main valve 7 of the heating circuit 1 is set so that all of the heating circuit medium flows from the flow line 1.1.1 into the reference flow path 1.2. In the reference flow path 1.2, the heating circuit medium then initially flows through the preferably provided buffer storage 6 and then escapes from the reference flow path 1.2 again and enters into the return line 1.1.2. In the return line 1.1.2, the heating circuit medium then initially passes through the heating circuit pump 3, then the filter, and thereafter the quantity measuring means 4, before it reaches into the heat exchanger 8. The speed of the heating circuit pump 3 and the flow rate of the heating circuit medium, which flows through the quantity measuring means 4, are now measured, and the conveying power reference value is determined therefrom and is stored in the electronic control means 5 of the heating system. The main valve 7 can now be reset back into its initial position again.

During the regular operation of the system, the main valve 7 is now once again set so that the heating circuit medium is only still conveyed through the reference flow path 1.2. As already described above, the speed of the heating circuit pump 3 and the flow rate of the heating circuit medium, which flows through the quantity measuring means 4, are then measured again here. The conveying power reference value is now determined from these variables and is stored in the electronic control means 5 of the heating system.

Lastly, the conveying power reference value is now compared with the conveying power value, and when reaching a predetermined deviation of the two values from one another, a signal is output, which indi-cates a fouling in the filter 2.

The method according to the invention thus represents a method, which is structurally quite simple, but nonetheless supplies efficient and in particular well-reproducible values, for the detection of a foiling of a filter 2 in a heating circuit.

### LIST OF REFERENCE NUMERALS

1 heating circuit
1.1 overall flow path
1.1.1 flow line
1.1.2 return line
1.2 sub-flow path—also reference flow path
1.3 sub-flow path
2 filter
3 heating circuit pump
4 quantity measuring means
5 control means
6 buffer storage
7 main valve
8 heat exchanger
9 radiator

1. A method for operating a heating system,
in which a heating circuit medium is conveyed through an overall flow path (1.1) of a heating circuit (1),
in which the heating circuit medium is conveyed at least through one of at least two sub-flow paths (1.2, 1.3), belonging to the overall flow path (1.1), of the heating circuit (1), in which there is control over how much heating circuit medium is respectively conveyed via the sub-flow paths (1.2, 1.3), and
in which the heating circuit medium, in order to clean the heating circuit medium of dirt, is routed through a filter (2) provided in the overall flow path (1.1), of the heating circuit (1),
wherein, when the heating system is started up, all of the heating circuit medium is routed via the sub-flow path (1.2), which optionally has the at least variable flow resistances or a known and/or an unchanging flow resistance, referred to as reference flow path (1.2), and a conveying power reference value is determined and saved, and
wherein in order to check a state of fouling of the filter (2), during operation of the heating system, all of the heating circuit medium is once again routed via the reference flow path, which is used during the start-up, a conveying power value is determined, the latter is compared with the conveying power reference value, and, beginning with a predetermined deviation, a signal indicating a fouling of the filter (2) is generated.

2. The method according to claim 1, wherein the heating circuit medium is conveyed through the heating circuit (1) by means of a heating circuit pump (3) and a heating circuit medium quantity, which is conveyed through the heating circuit (1), is determined by means of a quantity measuring means (4),
wherein the conveying power reference value and/or the conveying power value is optionally determined on the basis of the speed of the heating circuit pump (3) and on the basis of the heating circuit medium quantity acquired by means of the quantity measuring means (4).

3. The method according to claim 1,
wherein, when the heating system is started up and/or when the state of fouling of the filter (2) is checked, the heating circuit medium is routed through the reference flow path (1.2), which is formed in a valve-free manner.

4. The method according to claim 1,
wherein, when the heating system is started up and/or when the state of fouling of the filter (2) is checked, the heating circuit medium is routed through the reference flow path (1.2), which is formed in a heat exchanger-free manner.

5. The method according to claim 1,
wherein the conveying power reference value determined when the heating system is started up is stored in an electronic control means (5) of the heating system.

6. The method according to claim 1,
wherein, when the heating system is started up and/or when the state of fouling of the filter (2) is checked, the heating circuit medium is routed through a buffer storage (6), which is arranged in the reference flow path (1.2).

7. The method according to claim 1,
wherein, coming from the overall flow path (1.1), the heating circuit medium is optionally routed to the reference flow path (1.2) and/or to the other sub-flow path (1.3) by means of a main valve (7).

8. The method according to claim 1,
wherein the heating circuit medium is supplied to the heating circuit (1) via a flow line (1.1.1) belonging to the overall flow path (1.1) and is discharged from the heating circuit (1) via a return line (1.1.2) belonging to the overall flow path (1.1)

9. The method according to claim 8,
wherein the heating circuit medium is routed through the filter (2), which is arranged on the return line (1.1.2) of the heating circuit (1).

10. The method according to claim 8,
wherein the heating circuit medium is routed via a heat exchanger (8), which connects the return line (1.1.2) to the feed line (1.1.1).
